(19) United States
(12) Patent Application Publication
(10) Pub. No.: US 2025/0384540 A1
(43) Pub. Date: Dec. 18, 2025

(54) LEAD TAB ALIGNMENT DEVICE, BATTERY MANUFACTURING SYSTEM COMPRISING SAME, AND METHOD FOR MANUFACTURING BATTERY CELL BY BATTERY MANUFACTURING SYSTEM

(71) Applicant: SK ON CO., LTD., Seoul (KR)

(72) Inventors: Ju Hyeong BAE, Daejeon (KR); Kang San KIM, Daejeon (KR); Sang Jun PARK, Daejeon (KR); Kyu Kap LEE, Daejeon (KR); Do Wan CHA, Daejeon (KR)

(21) Appl. No.: 19/149,848

(22) PCT Filed: Jan. 30, 2024
(86) PCT No.: PCT/KR2024/001403

§ 371 Date: Jul. 22, 2025

(30) Foreign Application Priority Data
Jan. 30, 2023 (KR) 10-2023-0012078
Jan. 30, 2024 (KR) 10-2024-0013691

(51) Int. Cl. G06T 7/00; G06T 7/70; H01M 10/04

(52) U.S. Cl. CPC G06T 7/0004; G06T 7/70; H01M 10/0409; H01M 10/0431; G06T 2207/30108

(57) ABSTRACT

The present disclosure relates to lead tab alignment device comprising a photographing unit for photographing a battery cell including a lead tab portion under assembly, wherein the battery cell under assembly includes a case in which an electrode assembly and the lead tab portion electrically connected to the electrode assembly are arranged, and an alignment correction unit detachably coupled to the lead tab portion and for adjusting the position of the lead tab portion, and battery manufacturing system comprising same, and method for manufacturing battery cell by battery manufacturing system.

### CROSS-REFERENCE TO RELATED APPLICATION

This patent application is a national stage application of PCT/KR2024/001403 filed on Jan. 30, 2024, which claims priority to Korean patent application No. 10-2023-0012078, filed on Jan. 30, 2023, and Korean patent application No. 10-2024-0013691, filed on Jan. 30, 2024. The disclosure of each of the foregoing applications is incorporated herein by reference in its entirety.

### FIELD

The present disclosure relates to a lead tab alignment correction unit, a battery manufacturing system comprising the same, and a method for manufacturing battery cell in the battery manufacturing system. More particularly, it relates to a lead tab alignment correction unit that improves the efficiency of a battery cell manufacturing process, a battery manufacturing system comprising the same, and a method for manufacturing battery cells in the battery manufacturing system.

### BACKGROUND TECHNOLOGY

A battery cell may include an electrode assembly for producing electrical energy, a case accommodating the electrode assembly, and a lead tab portion electrically connected to the electrode assembly and protruding outwardly from the case.

To assemble the battery cell, a conventional battery manufacturing system may utilize a lead tab alignment device that aligns the lead tab portion after placing the electrode assembly and the lead tab portion connected with the electrode assembly in the case. A conventional lead tab alignment device may align the lead tab portions and position them in a preset fixed position. However, the lead tab alignment device does not fix the lead tab, but simply aligns the lead tab portions, which may cause a problem of misalignment of the lead tab portion when moving to a sealing device in the future.

In addition, the battery cell under assembly in the sealing device need to be re-aligned with the lead tab portion before sealing, which increases the time required to manufacture the battery cell.

### DETAILED DESCRIPTION OF THE INVENTION

### Technical Challenges

In one aspect of the present disclosure, the efficiency of a battery cell manufacturing process may be improved.

In another aspect of the present disclosure, the misalignment of lead tab portion of a battery cell under assembly after the lead tab portions are aligned may be prevented.

Another aspect of the disclosure, the lead tab portion may be aligned by Vision.

The lead tab alignment device according to the present disclosure and the battery cell manufactured through the battery manufacturing system including the lead tab alignment device according to the present disclosure can be widely applied in the field of green technology such as electric vehicles, battery charging stations, energy storage systems (ESS), photovoltaics, wind power, and other green technologies utilizing batteries. In addition, the lead tab alignment device according to the present disclosure and the battery cell manufactured through the battery manufacturing system including the lead tab alignment device according to the present disclosure can be used for eco-friendly mobility, including electric vehicles and hybrid vehicles to prevent climate change by suppressing air pollution and greenhouse gas emissions.

### Technical Workaround

To address the above challenges, a lead tab alignment device according to an embodiment of the present disclosure may comprise: a photographing unit for photographing a battery cell including a lead tab portion under assembly, wherein the battery cell under assembly includes a case in which an electrode assembly and the lead tab portion electrically connected to the electrode assembly are arranged; an alignment correction unit detachably coupled to the lead tab portion and for adjusting the position of the lead tab portion; and a control unit for controlling the photographing unit and the alignment correction unit; wherein the control unit may move the lead tab portion to a preset fixed position by the alignment correction unit according to a position information of the lead tab portion calculated from an image of the battery cell under assembly obtained by the photographing unit.

In an embodiment, the alignment correction unit may include: a gripper for gripping and moving the lead tab portion along a first direction in which the lead tab portion protrudes; and a tab alignment unit for moving the lead tab portion along a second direction perpendicular to a stacking direction in which an anode, a cathode, and a separator are stacked and the first direction in the electrode assembly including the anode, the cathode, and the separator arranged between the anode and the cathode.

In an embodiment, the tab alignment unit may include a first alignment unit and a second alignment unit extending along the first direction and contacting both sides of the lead tab portion along the second direction, respectively.

In an embodiment, the photographing unit may be spaced apart from the battery cell under assembly along the stacking direction and photographs the battery cell under assembly.

In an embodiment, the position information of the lead tab portion may include: a first length of the lead tab portion protruding from one end of the case along a first direction in which the lead tab portion protrudes; and a second length of the lead tab portion being spaced apart from other end of the case along a second direction perpendicular to the first direction and perpendicular a stacking direction in which an anode, a cathode, and a separator are stacked in the electrode assembly including the anode, the cathode, and the separator arranged between the anode and the cathode.

In an embodiment, the lead tab portion may include a lead tab electrically connected to the anode and the cathode, respectively, and a lead film extending along the second direction and wrapping a portion of the lead tab overlapping the case, wherein the first length may be a length from the one end of the case to one end of the lead film, and wherein the second length may be a length from the other end of the case to one side of the lead tab.

A battery manufacturing system according to another embodiment of the present disclosure may comprise: a lead tab alignment device including a photographing unit for photographing a battery cell including a lead tab portion under assembly, wherein the battery cell under assembly includes a case in which an electrode assembly and the lead tab portion electrically connected to the electrode assembly are arranged, and an alignment correction unit detachably coupled to the lead tab portion and adjusting the position of the lead tab portion; a first sealing device for sealing a portion of a preset sealing area of the case after aligning the lead tab portion by the lead tab alignment device; and a second sealing device for sealing the sealing area after sealing a portion of the sealing area.

In another embodiment, the first sealing device may perform a spot sealing to seal the sealing area intermittently.

In another embodiment, the lead tab alignment device and the first sealing device may align the lead tab portion at the same position and seal the portion of the sealing area.

In another embodiment, the alignment correction unit may include: a gripper for gripping and moving the lead tab portion along a first direction in which the lead tab portion protrudes; and a tab alignment unit for moving the lead tab portion along a second direction perpendicular to a stacking direction in which an anode, a cathode, and a separator are stacked and perpendicular to the first direction in the electrode assembly including the anode, the cathode, and the separator arranged between the anode and the cathode.

In another embodiment, the tab alignment unit may include a first alignment unit and a second alignment unit extending along the first direction and contacting both sides of the lead tab portion along the second direction, respectively.

In another embodiment, the photographing unit may be spaced apart from the battery cell under assembly along the stacking direction and photographs the battery cell under assembly.

A Manufacturing method of a battery cell of a battery manufacturing system according to another embodiment of the present disclosure may comprise: a step of providing a battery manufacturing system including a lead tab alignment device including a photographing unit for photographing a battery cell including a case under assembly in which an electrode assembly and a lead tab portion electrically connected to the electrode assembly are arranged, an alignment correction unit detachably coupled to the lead tab portion and adjusting the position of the lead tab portion, and a first sealing device and a second sealing device for sealing a preset sealing area of the case; a step of aligning the lead tab portion by moving the lead tab portion by the alignment correction unit according to the position information of the lead tab portion calculated from an image of the battery cell under assembly obtained by the photographing unit; a first sealing step for sealing a portion of a sealing area including a portion of the case where the lead tab portion protrudes by the first sealing device after aligning the lead tab portion; and a second sealing step for moving the battery cell under assembly and sealing the sealing area by the second sealing device after the first sealing step.

In another embodiment, the battery cell under assembly may be moved to perform the second sealing step after the step of aligning the lead tab portion and the first sealing step are performed.

In another embodiment, the manufacturing method of a battery cell of a battery manufacturing system further may comprise: a step of injecting an electrolyte into the case by an injection device for injecting the electrolyte after the second sealing step.

In another embodiment, the position information of the lead tab portion may include a first length of the lead tab portion protruding from one end of the case along a first direction in which the lead tab portion protrudes, and a second length of the lead tab portion being spaced apart from other end of the case along a second direction perpendicular to the first direction and perpendicular to a stacking direction in which an anode, a cathode, and a separator are stacked in the electrode assembly including the anode, the cathode, and the separator arranged between the anode and the cathode.

In another embodiment, the lead tab portion may include a lead tab electrically connected to the anode and the cathode respectively and a lead film wrapping a portion that overlaps with the sealing area of the case extending along the second direction where the lead tab portion protrudes, wherein the first length may be a length from the one end of the case to one end of the lead film, and wherein the second length may be a length from the other end of the case to one side of the lead tab.

### Effect

According to one embodiment of the present disclosure, the efficiency of a battery cell manufacturing process may be improved.

According to another embodiment of the present disclosure, the lead tab portion of a battery cell under assembly can be prevented from becoming misaligned after being aligned.

In another embodiment of the present disclosure, Vision can be utilized to align the lead tab portion.

### DESCRIPTION OF THE DRAWING

FIG. 1 illustrates an example of a battery cell under assembly including an electrode assembly, a lead tab portion electrically connected to the electrode assembly, and a case.

FIG. 2 illustrates an example of a battery cell under assembly.

FIG. 3 illustrates schematically a method of aligning lead tab portion using a lead tab alignment device.

FIG. 4 illustrates an example of an image obtained by a photographing unit for photographing a battery cell under assembly including a lead tab portion.

FIG. 5 illustrates a portion of a battery manufacturing system.

FIG. 6 illustrates an example of sealing a portion of the sealing area of a case after aligning a lead tab portion.

FIG. 7 is a flowchart illustrating an example of manufacturing method of the battery cell.

### EMBODIMENTS

Preferred embodiments of the present disclosure will be described in detail hereinafter with reference to the accompanying drawings. The apparatus configurations and control methods described herein are intended to illustrate embodiments of the present disclosure and are not intended to limit the scope of the disclosure, and like reference numerals used throughout the specification refer to like components.

Certain terms used herein are for convenience of description only and are not intended to be limiting to the embodiments shown.

For example, expressions such as “identical” and “identical to” refer not only to strictly identical states, but also to states where tolerances, or differences in the degree to which the same functionality is achieved, exist.

For example, expressions that indicate relative or absolute placement, such as “in a direction,” “along a direction,” “side by side,” “perpendicular,” “centered,” “concentric,” or “coaxial,” not only strictly indicate such placement, but also indicate a tolerance, or a state of relative displacement by an angle or distance that results in the same function.

The use of terms such as “first,” “second,” “third,” and the like to precede components referred to herein is intended only to avoid confusion as to the components to which they refer and does not indicate any order, importance, or master-servant relationship among the components. For example, it is possible to practice an invention comprising only the second component without the first component.

As used herein, expressions in the singular include the plural unless the context clearly indicates otherwise.

As used herein, an assembled battery cell refers to a battery cell in a state in which the electrode assembly and lead tabs have been electrically connected and placed in a case during the manufacture of the battery cell, i.e., the electrode assembly may be accommodated inside the case and a portion of the lead tab portions may be placed in the case with a portion of the lead tab portions protruding outwardly from the case. Furthermore, depending on the steps of the battery cell manufacturing method, the battery cell under assembly may have a sealed case, a partially sealed case, or may not yet be sealed.

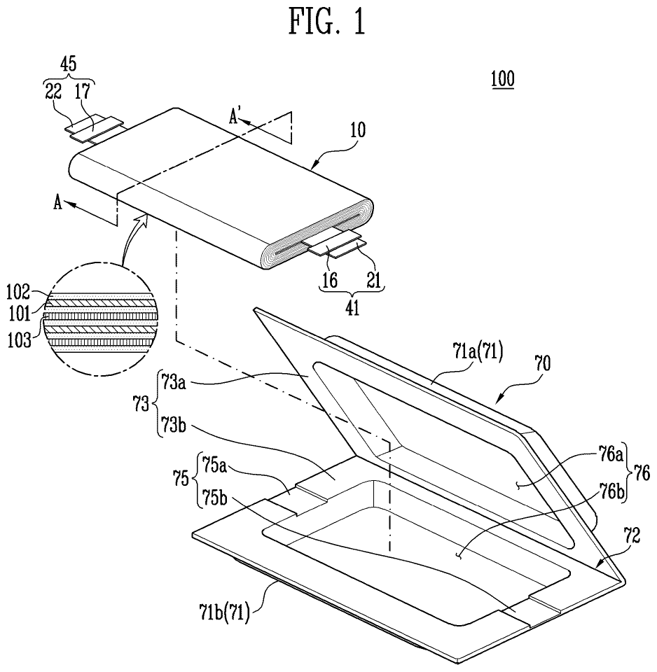

FIG. 1 illustrates an example of a battery cell under assembly including an electrode assembly, a lead tab portion electrically connected to the electrode assembly, and a case.

Referring to FIG. 1, a battery cell 100 may include an electrode assembly 10 that produces or stores electrical energy, a case 70 that accommodates the electrode assembly 10, and lead tab portions 41, 45 that are electrically connected to the electrode assembly 10 and protrude outwardly from the case 70.

Referring to a one side view of the electrode assembly 10 cut along A-A′, the electrode assembly 10 may comprise an anode 101 on which an anodic active material is applied, a cathode 103 disposed to face the anode 101, and a separator 102 disposed between the anode 101 and the cathode 103. The anode 101 and the cathode 103 may each comprise a plurality of pieces, and may be stacked along a preset stacking direction. The separator 102 may be disposed between each of the plurality of anodes 101 and the plurality of cathodes 103 to separate the anodes 101 from the cathodes 103.

The lead tab portions 41, 45 may include lead tabs 21, 22 electrically connected to the anode 101 and the cathode 103, respectively, and lead films 16, 17 extending along a second direction perpendicular to the first direction, which is the direction of stacking and in which the lead tab portions 41, 45 protrude, and wrapping a portion of the lead tab portions 41, 45.

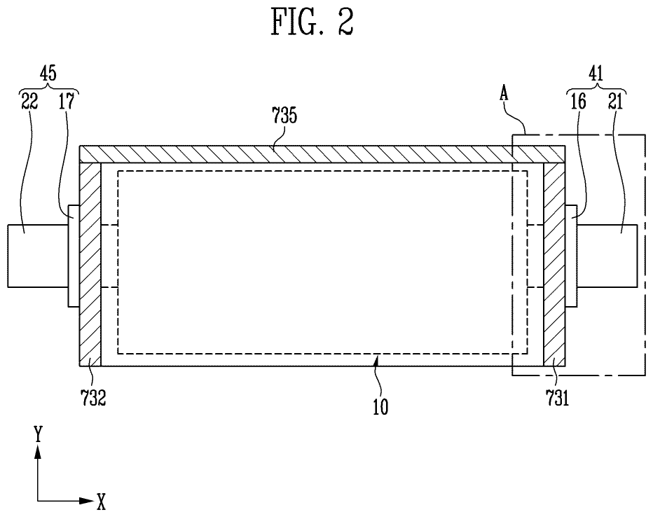

More specifically, the lead tab portions 41, 45 may include lead tabs 21, 22 that connect with each lead (not shown) of the plurality of anodes 101 and each lead (not shown) of the plurality of cathodes 103. Further, the lead films 16, 17 may wrap the lead tabs 21, 22 in a position overlapping the sealing area 73 of the case 70 (see FIG. 2).

The lead films 16, 17 may be positioned between the lead tabs 21, 22 and the case 70 to provide a better seal when sealing the sealing areas 731, 732 of the case 70. To this end, the lead films 16, 17 may be formed from a polymeric material such as polypropylene.

The case 70 may comprise a first body 71a and a second body 71b forming an accommodation space 76 for accommodating the electrode assembly 10. The first body 71a and the second body 71b may not be separate members, but may be items formed by folding a single sheet-like member 71, i.e., a single sheet-like member 71 may be folded about a fold line 72 to form the first body 71a and the second body 71b, respectively.

The first body 71a may comprise a first recessed space 76a recessed to form a portion of the accommodation space 76. Similarly, the second body 71b may include a second recessed space 76b that is recessed in a direction opposite to the direction in which the first recessed space 76a is recessed to form a portion of the accommodation space 76.

When the first body 71a and the second body 71b are folded with respect to the folding line 72, the first recess 76a and the second recess 76b may form a single accommodation space 76 with the openings of both spaces merging.

The first body 71a may further comprise a first contact portion 73a wrapping around the perimeter of the first recess 76a and extending in a direction perpendicular to the stacking direction. The second body 71b may further comprise a second contact portion 73b wrapping around the perimeter of the second recess 76b and extending in a direction perpendicular to the stacking direction. The first contact portion 73a and the second contact portion 73b may be collectively referred to as folding portion 73.

When the first body 71a and the second body 71b are folded relative to the folding line 72 to form the accommodation space 76, the first contact portion 73a and the second contact portion 73b may be in contact with each other and sealed. This is to prevent leakage of the electrolyte (not shown) injected into the accommodation space 76.

On the other hand, the lead tab portions 41, 45 may protrude outwardly of the case 70 for electrical connection with the outside. Since the lead tab portions 41, 45 have the shape of a thin plate made of metal, they may protrude outwardly from the case 70 through a gap between the first contact portion 73a and the second contact portion 73b.

However, since the first contact portion 73a and the second contact portion 73b will be sealed, the sealing of the first contact portion 73a and the second contact portion 73b may be damaged due to interference with the lead tab portions 41, 45. To prevent this, the contact portion of either of the first contact portion 73a and the second contact portion 73b may comprise a recess 75 that is recessed corresponding to the shape of the lead tab portions 41, 45.

Referring to FIG. 1, the lead tab portions 41, 45 may comprise lead tabs 21, 22 that serve as terminals to electrically connect the electrode assembly 10 to the outside, and lead films 16, 17 that enclose an area of the lead tabs 21, 22 that overlaps and contacts the case 70.

In other words, the lead films 16, 17 may serve in pressing the first contact portion 73a and the second contact portion 73b against the lead tabs 21, 22 such that a closing contact is achieved between the first contact portion 73a and the second contact portion 73b and the lead tabs 21, 22.

In order to manufacture the battery cell 100, firstly, the electrode assembly 10 and lead tab portions 41, 45 electrically connected to the electrode assembly 10 may be disposed in the case 70. The electrode assembly 10 may be disposed in the accommodation space 76, and the lead tab portions 41, 45 may protrude outwardly of the case through the recess 75.

Referring to FIG. 1, the recess 75 may include a first recess 75a and a second recess 75b into which the lead tab portions 41, 45 are inserted, respectively.

Furthermore, while FIG. 1 illustrates lead tab portions 41, 45 projecting in opposite directions past the first recess 75a and the second recess 75b, this is only an example, and it will be appreciated that the first recess 75a and the second recess 75b may be located in the same direction and the lead tab portions 41, 45 may project in the same direction.

In the present specification, the direction in which the anode 101 and the cathode 103 of the electrode assembly 10 are stacked is referred to as the stacking direction, and the direction in which the lead tab portions 41, 45 protrude in a direction perpendicular to the stacking direction is referred to as the first direction (or X direction), and the direction perpendicular to the stacking direction and the first direction is referred to as the second direction (or Y direction).

FIG. 2 illustrates an example of a battery cell under assembly.

After the electrode assembly 10 and the lead tab portions 41, 45 have been placed in the case 70, an electrolyte may be injected into the interior of the case 70. For this purpose, the case 70 may be sealed except for the area where the electrolyte is injected.

Since the case 70 is formed by folding the first body 71a and the second body 71b relative to the folding line 72 (see FIG. 1), sealing will be required on three sides of the case, except in the area where the folding line 72 is located. Specifically, when the first body 71a and the second body 71b are folded, it is necessary to seal the area where the first contact portion 73a and the second contact portion 73b are in contact with each other.

The folding portion 73, see FIG. 1, may comprise a portion from which the lead tab portions 41, 45 protrude and may comprise sealing areas 731, 732 extending along the second direction.

Furthermore, the folding portion 73 may comprise a joining area 735 connecting the sealing areas 731, 732 to each other along the first direction, wherein the sealing areas 731, 732 are areas where the first body 71a and the second body 71b are in contact with each other along the second direction, and wherein the joining area 735 is an area where the first body 71a and the second body 71b are in contact with each other along the first direction. The joining area 735 may be connected to the sealing areas 731, 732.

More specifically, the sealing areas 731, 732 may be areas formed by contacting portions extending along the second direction of the first contact portion 73a and the second contact portion 73b with each other, and the joining area 735 may be areas formed by contacting portions extending along the first direction of the first contact portion 73a and the second contact portion 73b with each other.

The joining area 735 may be located in the opposite direction to the folding line, across the accommodation space 76.

Prior to sealing the sealing areas 731, 732 and the joining area 735, the battery cell manufacturing method according to the present disclosure requires alignment of the lead tab portions 41, 45. This is because if the electrode assembly 10 and the lead tab portions 41, 45 are simply placed in the case 70, the lead tab portions 41, 45 may not be located in a preset fixed position due to manufacturing process errors. However, since the lead tab portions 41, 45 are not fixed in the fixed position, there is a risk that the position of the lead tab portions 41, 45 may change depending on the vibration of the battery cell under assembly or the movement of the battery cell under assembly.

To prevent this, the lead tab alignment device 500 according to the present disclosure may align the lead tab portions 41, 45 prior to sealing the sealing areas 731, 732.

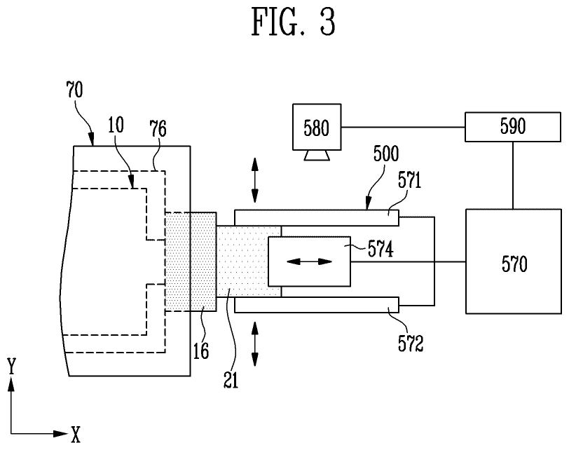

FIG. 3 illustrates schematically a method of aligning lead tab portion using a lead tab alignment device.

A lead tab alignment device 500 according to the present disclosure may include a photographing unit 580 for photographing a battery cell 100 under assembly including a lead tab portion 41, and the battery cell 100 under assembly may include a case 70 in which the electrode assembly 10 and the lead tab portion 41 (see FIG. 1) electrically connected to the electrode assembly 10 are disposed; and an alignment correction units 571, 572, 574 detachably coupled to the lead tab portion 41 to adjust the position of the lead tab portion 41.

Further, the lead tab alignment device 500 may further include a control unit 590 that controls the photographing unit 580 and the alignment correction units 571, 572, 574.

Further, the lead tab alignment device 500 may further comprise a drive portion 570 that is controlled by the control unit 590 to control movement of the alignment correction units 571, 572, 574.

The drive portion 570 may comprise a motor or actuator to control movement along the first and/or second direction of the alignment correction units 571, 572, 574.

The alignment correction units 571, 572, 574 may include a gripper 574 for gripping and moving the lead tab portion 41 along the first direction, and tab alignment units 571, 572 for moving the lead tab portion 41 along the second direction.

Referring to FIG. 3, the gripper 574 may grip one end of the lead tab portion 41 along the first direction to vary the position of the lead tab portion 41 along the first direction.

The tab alignment units 571, 572 may be located at both ends of the lead tab portion 41 along the second direction to allow for variable positioning of the lead tab portion 41 along the second direction.

The gripper 574 grasps and moves the lead tab portion 41, while the tab alignment units 571, 572 extend alongside the lead tab portion 41 along the first direction, and may contact both ends of the lead tab portion 41 along the second direction, but do not grip both ends of the lead tab portion 41.

Whereas a conventional lead tab alignment device 500 simply contacts the lead tab portions 41, 45 (see FIG. 1) without gripping them by the tab alignment units 571, 572, thereby varying the position of the lead tab portions 41, 45 along the first direction and the second direction to align them, Whereas the lead tab alignment device 500 according to the present disclosure utilizes the gripper 574 to hold the lead tab portions 41, 45, so as to minimize misalignment of the lead tab portions 41, 45 while performing different processes.

The tab alignment units 571, 572 may include a first alignment unit 571 and a second alignment unit 572 extending along the first direction and contacting both sides or ends of the lead tab portion along the second direction, respectively. The first alignment unit 571 and the second alignment unit 572 may extend in parallel with the lead tab portions 41, 45 along the first direction.

On the other hand, the photographing unit 580 may be spaced apart from the battery cell under assembly 100 along the stacking direction to photograph the battery cell under assembly 100. In FIG. 3, the photographing unit 580 is illustrated as being located at the battery cell under assembly 100 along the Y-direction, but from a three-dimensional spatial perspective, the photographing unit 580 may photograph the battery cell under assembly 100 while looking at the battery cell under assembly 100 from above.

For example, the photographing unit 580 may be a camera or video camera.

The control unit 590 may move the lead tab portions 41, 45 to a preset fixed position by the alignment correction units 571, 572, 574 according to the position information of the lead tab portions 41, 45 calculated from the image of the battery cell 100 under assembly obtained by the photographing unit 580.

In other words, the control unit 590 may control the drive portion 570 to control movement of the gripper 574 and the tab alignment units 571, 572.

More specifically, the gripper 574 will grip the lead tabs 21, 22 (see FIG. 1) to align the lead tabs 21, 22 along the first direction, and the tab alignment units 571, 572 will be located on either side of the lead tabs 21, 22 along the second direction of the lead tabs 21, 22 to align the lead tabs 21, 22.

Since the lead tabs 21, 22 are connected with the lead films 16, 17 and the electrode assemblies 10, the alignment of the lead tabs 21, 22 may also affect the position of the lead films 16, 17 and the electrode assemblies 10 located in the accommodation space 76.

In FIG. 3, the lead tab alignment device 500 is shown with only one lead tab portion 41 (see FIG. 2), but the lead tab alignment device 500 may also align another lead tab 45 (see FIG. 2) at the same time or at a later time. If multiple lead tab portions 41, 45 are provided in the same direction in the case 70, the lead tab alignment device 500 may be able to align multiple lead tab portions 41, 45 simultaneously.

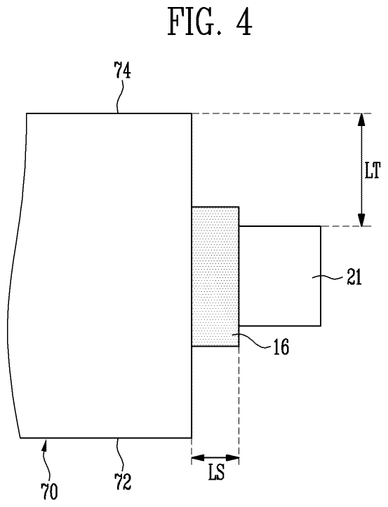

FIG. 4 illustrates an example of an image obtained by a photographing unit for photographing a battery cell under assembly including a lead tab portion.

The control unit 590 (see FIG. 3) may move the lead tab portion 41 to a preset fixed position by the alignment correction units 571, 572, 574 according to the position information of the lead tab portion 41 calculated from an image of a first area of the battery cell 100 under assembly obtained by the photographing unit 580.

The position information of the lead tab portion 41 may include a first length of the lead tab portion 41 protruding from one end of the case 70 along the first direction, and a second length of lead tab portion 41 being spaced from other end of the case 70 along a second direction perpendicular to the stacking direction and the first direction.

More specifically, the first length may be a length LS from one end of the case 70 along the first direction to one end of the lead film 16, 17. The second length may be a length LT from the other end of the case 70 along the second direction to a side of the lead tabs 21, 22.

Referring to FIG. 4, the first length may be a length to a free end of the lead film 16, 17 in a direction away from one end of the case 70 along the first direction. Further, the second length may be a length from the other side of the case 70 located on the opposite side of the fold line 72 along the second direction to a one side of the lead tabs 21, 22 in a direction toward the fold line 72.

After the control unit 590 calculates the position in which the lead tab portion 41 is disposed by the first length and the second length, the control unit 590 can move the lead tab portion 41 to the fixed position by the alignment correction units 571, 572, 574. Since the control unit 590 calculates the first length and the second length based on images obtained through the photographing unit 580, the lead tab alignment device 500 according to the present disclosure may be referred to as a vision type lead tab alignment device 500.

While FIG. 4 is illustrated using only one lead tab portion 41, the remaining lead tab 45 may likewise be aligned by the alignment correction units 571, 572, 574 based on images obtained through the photographing unit 580.

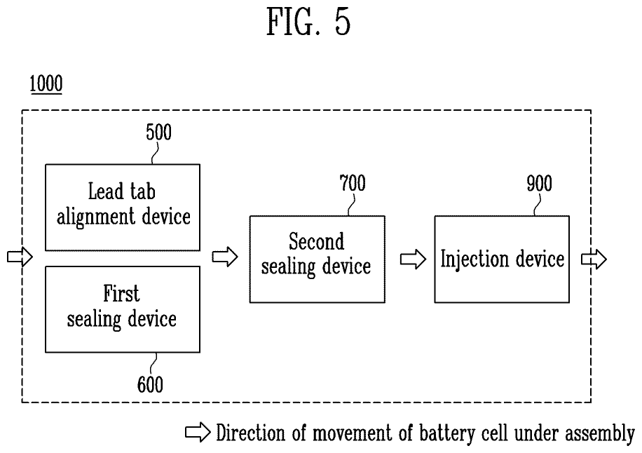

FIG. 5 illustrates a portion of a battery manufacturing system.

The battery manufacturing system 1000 according to the present disclosure may include a lead tab alignment device 500, a first sealing device 600 and a second sealing device 700 for sealing the battery cell 100 under assembly, and an injection device 900 for injecting electrolyte into the interior of the case 70.

Referring to FIG. 5, the arrows indicate the direction of movement of the battery cell 100 under assembly. Referring to FIG. 5, the lead tab alignment device 500 and the first sealing device 600 can align the lead tab portions 41, 45 and seal a portion of the sealing areas 731, 732, respectively, when the battery cell 100 under assembly is in the same position.

In a conventional battery manufacturing system, after aligning the lead tab portions 41, 45, the sealing areas 731, 732 may be sealed prior to the injection of electrolyte. However, since the battery cell 100 under assembly must be moved for sealing, the lead tab portions 41, 45 may shift during movement, which may displace the aligned position of the lead tab portions 41, 45.

In order to prevent misalignment of the lead tab portions 41, 45, the battery manufacturing system 1000 according to the present disclosure may, using the first sealing device 600, seal a portion of the sealing areas 731, 732 in order to fix the lead tab portions 41, 45 in a preset fixed position prior to movement of the battery cell 100 under assembly.

Thereafter, the battery cell 100 under assembly may be moved towards the second sealing device 700. The second sealing device 700 may seal the sealing areas 731, 732.

The battery cell 100 under assembly may then be moved towards the injection device 900 for injecting the electrolyte.

The battery manufacturing system may further comprise a sealing device (not shown) for sealing the joining area 735 after the injection of the electrolyte is completed.

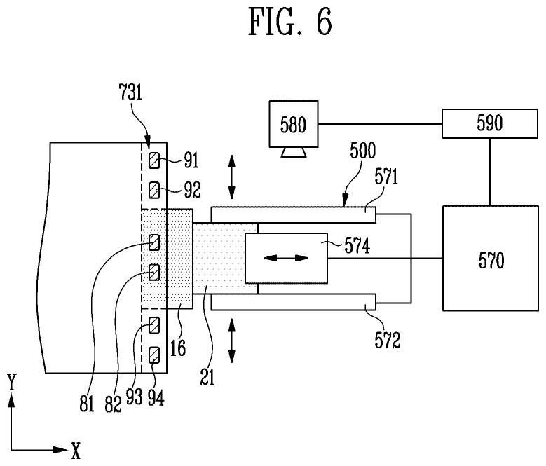

FIG. 6 illustrates an example of sealing a portion of the sealing area of a case after aligning a lead tab portion.

More specifically, FIG. 6 shows the battery cell 100 in a state in which the lead tab alignment device 500 has aligned the lead tab portions 41, 45 to the fixed positions and the first sealing device 600 has sealed a portion of the sealing area 731.

As described above, the sealing area 731 is an area extending along the second direction that includes the portion of the case 70 from which the lead tab portions 41, 45 protrude.

Referring to FIG. 6, it can be seen that the first sealing device 600 performs sealing discontinuously or intermittently along the second direction in the sealing areas 731, 732. This may be referred to as spot sealing. This is to fix the position of the lead tab portion 41 by sealing a part of the case 70 rather than the sealing.

Further, the battery cell 100 under assembly may include another sealing area 732 (see FIG. 2) opposite the sealing area 731 shown in FIG. 6 relative to the case 70, and other lead tab portion 45 (see FIG. 1) partially overlapping the another sealing area 732. The battery cell manufacturing methods described herein may be equally applicable to the another sealing area 732 and the other lead tab portion 45.

The area where the spot sealing is performed may be an area 91 to 94 of the sealing area that does not overlap with the lead film 16, 17. Alternatively, the area where the spot sealing is performed may be an area 81, 82 that overlaps with the lead film 16. There may be a plurality of areas in which the spot sealing is performed, and their position may be varied.

For example, the area in which the spot sealing is performed may be arranged in a plurality of columns rather than a single column along the second direction.

While the spot sealing is being performed, the lead tab alignment device 500 may continue to calibrate the fixed position of the lead tab portion 41 by the alignment correction units 571, 572, 574 based on images obtained by the photographing unit 580, in order to hold the lead tab portion 41 in the fixed position.

Since the area in which the spot sealing is performed overlaps with the sealing areas 731, 732, the spot sealing performed through the first sealing device 600 may disappear or become indistinguishable after the sealing of the sealing areas 731, 732 performed through the second sealing device 700.

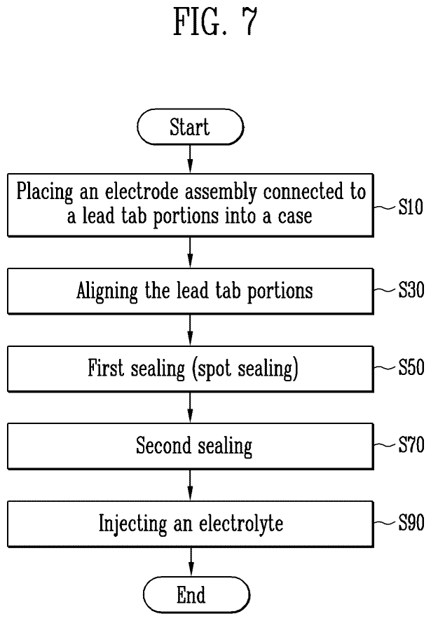

FIG. 7 is a flowchart illustrating an example of manufacturing method of the battery cell.

A battery cell manufacturing method of a battery manufacturing system 1000 according to the present disclosure, comprising the step S30 of aligning the lead tab portions 41, 45 by moving the lead tab portions 41, 45 by the alignment correction units 571, 572, 574 according to position information of the lead tab portions 41, 45 calculated from an image of the battery cell 100 under assembly obtained by the photographing unit 580, a first sealing step S50 for sealing a portion of a sealing area 731, 732 including a portion of the case 70 where the lead tab portions 41, 45 protrude by the first sealing device 600 after aligning the lead tab portions 41, 45, and a second sealing step S70 for moving the battery cell 100 under assembly and sealing the sealing area 731, 732 by the second sealing device 700 after the first sealing step S50.

The step S30 of aligning the lead tab portions 41, 45 may be performed by the lead

tab alignment device 500. Further, the position of the battery cell 100 under assembly in the step S30 of aligning the lead tab portions 41, 45 may be the same as the position of the battery cell 100 under assembly in the step S50 of first sealing.

Upon completion of the first sealing step S50, the battery cell manufacturing method according to the present disclosure may move the assembled battery cell 100 to perform a second sealing step S70 to seal the sealing areas 731, 732.

Upon completion of the second sealing step S70, the battery cell manufacturing method according to the present disclosure may inject electrolyte S90 through the joining area 735 in which the case 70 has not yet been sealed. The battery cell manufacturing method according to the present disclosure may then seal the joining area 735.

On the other hand, a battery cell manufacturing method according to the present disclosure may perform a step S10 of placing the electrode assembly 10 and the lead tab portions 41, 45 in the case 70 prior to a step S30 of aligning the lead tab portions 41, 45.

The present disclosure may be practiced in various variations, and the scope of the disclosure is not limited to the embodiments described above. Therefore, if a variation includes the components of the patent claims of the present disclosure, it should be considered to fall within the scope of the disclosure.

What is claimed is:

1. A lead tab alignment device comprising:
a photographing unit for photographing a battery cell including a lead tab portion under assembly, wherein the battery cell under assembly includes a case in which an electrode assembly and the lead tab portion electrically connected to the electrode assembly are arranged;
an alignment correction unit detachably coupled to the lead tab portion and for adjusting the position of the lead tab portion; and
a control unit for controlling the photographing unit and the alignment correction unit;
wherein the control unit moves the lead tab portion to a preset fixed position by the alignment correction unit according to a position information of the lead tab portion calculated from an image of the battery cell under assembly obtained by the photographing unit.

2. The lead tab alignment device according to claim 1, wherein the alignment correction unit includes:
a gripper for gripping and moving the lead tab portion along a first direction in which the lead tab portion protrudes; and
a tab alignment unit for moving the lead tab portion along a second direction perpendicular to a stacking direction in which an anode, a cathode, and a separator are stacked and the first direction in the electrode assembly including the anode, the cathode, and the separator arranged between the anode and the cathode.

3. The lead tab alignment device according to claim 2, wherein the tab alignment unit includes a first alignment unit and a second alignment unit extending along the first direction and contacting both sides of the lead tab portion along the second direction, respectively.

4. The lead tab alignment device according to claim 2, wherein the photographing unit is spaced apart from the battery cell under assembly along the stacking direction and photographs the battery cell under assembly.

5. The lead tab alignment device according to claim 1, wherein the position information of the lead tab portion includes:
a first length of the lead tab portion protruding from one end of the case along a first direction in which the lead tab portion protrudes; and
a second length of the lead tab portion being spaced apart from other end of the case along a second direction perpendicular to the first direction and perpendicular a stacking direction in which an anode, a cathode, and a separator are stacked in the electrode assembly including the anode, the cathode, and the separator arranged between the anode and the cathode.

6. The lead tab alignment device according to claim 5, wherein the lead tab portion includes a lead tab electrically connected to the anode and the cathode, respectively, and a lead film extending along the second direction and wrapping a portion of the lead tab overlapping the case,
wherein the first length is a length from the one end of the case to one end of the lead film, and
wherein the second length is a length from the other end of the case to one side of the lead tab.

7. A battery manufacturing system comprising:
a lead tab alignment device including a photographing unit for photographing a battery cell including a lead tab portion under assembly, wherein the battery cell under assembly includes a case in which an electrode assembly and the lead tab portion electrically connected to the electrode assembly are arranged, and an alignment correction unit detachably coupled to the lead tab portion and adjusting the position of the lead tab portion;
a first sealing device for sealing a portion of a preset sealing area of the case after aligning the lead tab portion by the lead tab alignment device; and
a second sealing device for sealing the sealing area after sealing a portion of the sealing area.

8. The battery manufacturing system according to claim 7, wherein the first sealing device performs spot sealing to seal the sealing area intermittently.

9. The battery manufacturing system according to claim 7, wherein the lead tab alignment device and the first sealing device align the lead tab portion at the same position and seal the portion of the sealing area.

10. The battery manufacturing system according to claim 7, wherein the alignment correction unit includes: a gripper for gripping and moving the lead tab portion along a first direction in which the lead tab portion protrudes; and a tab alignment unit for moving the lead tab portion along a second direction perpendicular to a stacking direction in which an anode, a cathode, and a separator are stacked and perpendicular to the first direction in the electrode assembly including the anode, the cathode, and the separator arranged between the anode and the cathode.

11. The battery manufacturing system according to claim 10, wherein the tab alignment unit includes a first alignment unit and a second alignment unit extending along the first direction and contacting both sides of the lead tab portion along the second direction, respectively.

12. The battery manufacturing system according to claim 10, wherein the photographing unit is spaced apart from the battery cell under assembly along the stacking direction and photographs the battery cell under assembly.

13. A Manufacturing method of a battery cell of a battery manufacturing system comprising:
a step of providing a battery manufacturing system including a lead tab alignment device including a photographing unit for photographing a battery cell including a case under assembly in which an electrode assembly and a lead tab portion electrically connected to the electrode assembly are arranged, an alignment correction unit detachably coupled to the lead tab portion and adjusting the position of the lead tab portion, and a first sealing device and a second sealing device for sealing a preset sealing area of the case;
a step of aligning the lead tab portion by moving the lead tab portion by the alignment correction unit according to the position information of the lead tab portion calculated from an image of the battery cell under assembly obtained by the photographing unit;
a first sealing step for sealing a portion of a sealing area including a portion of the case where the lead tab portion protrudes by the first sealing device after aligning the lead tab portion; and
a second sealing step for moving the battery cell under assembly and sealing the sealing area by the second sealing device after the first sealing step.

14. The manufacturing method of a battery cell of a battery manufacturing system according to claim 13, wherein the battery cell under assembly is moved to perform the second sealing step after the step of aligning the lead tab portion and the first sealing step are performed.

15. The manufacturing method of a battery cell of a battery manufacturing system according to claim 14, further comprising:
a step of injecting an electrolyte into the case by an injection device for injecting the electrolyte after the second sealing step.

16. The manufacturing method of a battery cell of a battery manufacturing system according to claim 13, wherein the position information of the lead tab portion includes a first length of the lead tab portion protruding from one end of the case along a first direction in which the lead tab portion protrudes, and a second length of the lead tab portion being spaced apart from other end of the case along a second direction perpendicular to the first direction and perpendicular to a stacking direction in which an anode, a cathode, and a separator are stacked in the electrode assembly including the anode, the cathode, and the separator arranged between the anode and the cathode.

17. The manufacturing method of a battery cell of a battery manufacturing system according to claim 16, wherein the lead tab portion includes a lead tab electrically connected to the anode and the cathode respectively and a lead film wrapping a portion that overlaps with the sealing area of the case extending along the second direction where the lead tab portion protrudes,
wherein the first length is a length from the one end of the case to one end of the lead film, and
wherein the second length is a length from the other end of the case to one side of the lead tab.
